(19) United States
(12) Patent Application Publication
(10) Pub. No.: US 2009/0249245 A1
(43) Pub. Date: Oct. 1, 2009

(54) INFORMATION PROCESSING APPARATUS

(75) Inventor: Jun Watanabe, Fussa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/395,119

(22) Filed: Feb. 27, 2009

(30) Foreign Application Priority Data
Mar. 31, 2008 (JP) 2008-093936

(51) Int. Cl. G09G 5/00; G06F 3/048; G06K 9/00

(52) U.S. Cl. 715/802; 345/156; 345/1.3; 382/103

(57) ABSTRACT

An information processing apparatus includes: a display controller configured to control a plurality of display devices each having a display screen to display one or more application windows on the respective display screen; an user interface configured to accept an operation input by a user for operating the application window; a screen identifying module configured to identify a target display screen from among the display screens of the display devices, the target display screen being currently gazed on by a user; and a switch configured to switch a subject of the operation input through the user interface to the application windows displayed on the target display screen.

### CROSS REFERENCE TO RELATED APPLICATION(S)

The present disclosure relates to the subject matters contained in Japanese Patent Application No. 2008-093936 filed on Mar. 31, 2008, which are incorporated herein by reference in its entirety.

### FIELD

The present invention relates to an information processing apparatus.

### BACKGROUND

Personal computers provided with a capability of displaying different application windows on two or more displays have been widely used in recent years. It is assumed that each of these computers is used for the purpose of displaying an application window of word processing software on a first display while displaying an application window for browsing a web page on a second display. It is therefore possible to reduce troublesomeness and complication for simultaneously operating and processing a plurality of applications.

In a computer system thus configured, which operates application programs by using a plurality of displays, pointing devices such as a mouse are generally used when an operation input received by an input device such as a keyboard for operating an application window is switched between application windows placed on different displays.

Among these pointing devices, some pointing devices are provided with a function of executing a process of switching an operation input between application windows placed on different displays without use of manual operation. For example, a pointing device which achieves pointing by specifying an eye gaze position on a display screen based on user's eye gaze information given from an eye camera and mark information captured on the display screen by a visual field camera has been proposed. An example of such pointing device is disclosed in JP-A-7-253843.

However, user's convenience has not been taken into consideration in the device disclosed in the publication JP-A-7253843. For example, a user has to mount an eye camera in the device disclosed in the publication JP-A-7-253843 in order to make the device detect user's gaze points. This lacks user's convenience.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a perspective view showing an example of the outline of an information processing apparatus according to an embodiment of the invention.

FIG. 2 is a block diagram showing an example of the systematic configuration of the information processing apparatus according to the embodiment.

FIG. 3 is a block diagram showing the functional configuration of programs used in the information processing apparatus according to the embodiment.

FIG. 4 is a view showing multi-display based on a display operation application program in the embodiment.

FIG. 5 is a view showing a method for extracting feature points of a user's face in the embodiment.

FIGS. 6A and 6B are views showing methods of setting display arrangement for multi-display in the embodiment.

FIG. 7 is a flow chart showing a flow of multi-display setting in the embodiment.

### DETAILED DESCRIPTION OF THE EMBODIMENTS

An embodiment of the invention will be described below with reference to the drawings.

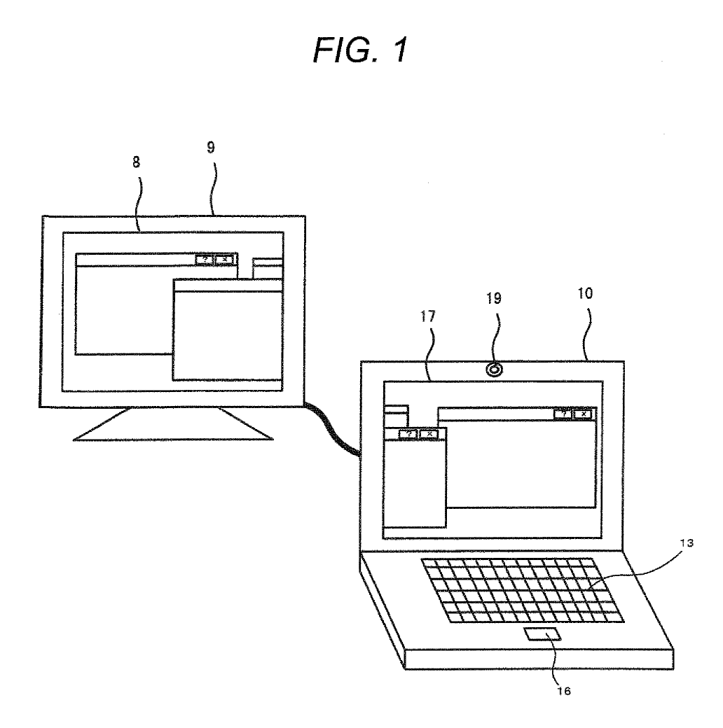

Referring first to FIG. 1, a configuration of an information processing apparatus according an embodiment of the invention will be described. For example, the information processing apparatus according to the embodiment is implemented as a notebook-type portable personal computer 10 which can be connected to an external display device 9.

When the personal computer 10 is connected to the external display device 9, the personal computer 10 performs a multi-display function by which application windows to be operated and processed by the personal computer 10 are displayed not only on a display 17 provided in the personal computer 10 but also on a display 8 of the external display device 9.

The personal computer 10 is provided with a camera 19 which captures image of a user's face. The personal computer 10 has a function of identifying a display currently gazed on by the user by analyzing the user's face image picked up by the camera 19. With this function, the personal computer 10 realizes a process of switching an operation input to an application window placed on the display gazed on by the user.

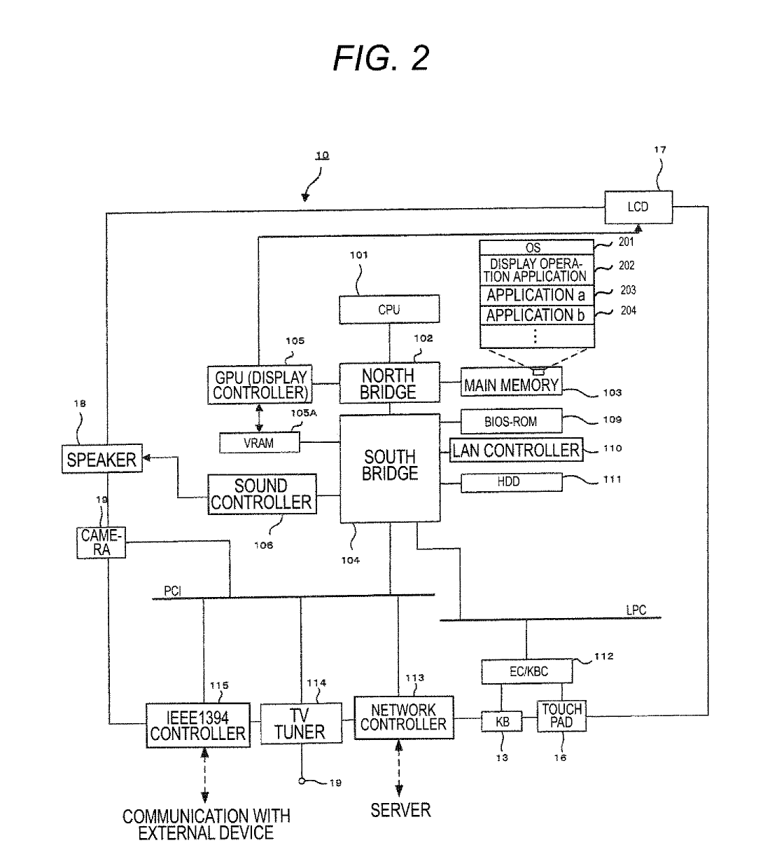

FIG. 2 is a block diagram showing the systemic configuration of the computer 10. As shown in FIG. 2, the computer 10 has a CPU 101, a north bridge 102, a main memory 103, a south bridge 104, a graphics processing unit (GPU) 105, a video memory (VRAM) 105A, a sound controller 106, a BIOS-ROM 109, an LAN controller 110, a hard disk drive (HOD) 111, an embedded controller/keyboard controller IC (EC/NBC) 112, a network controller 113, a TFT-LCD (Thin Film Transistor Liquid Crystal Display) 17, and the camera 19.

The CPU 101 is a processor for controlling operation of the computer 10. The CPU 101 runs an operating system (OS) 201 and various application programs such as application programs 202 to 204. The OS 201 and the application programs 202 to 204 are loaded into the main memory 103 from the hard disk drive (HDD) 111.

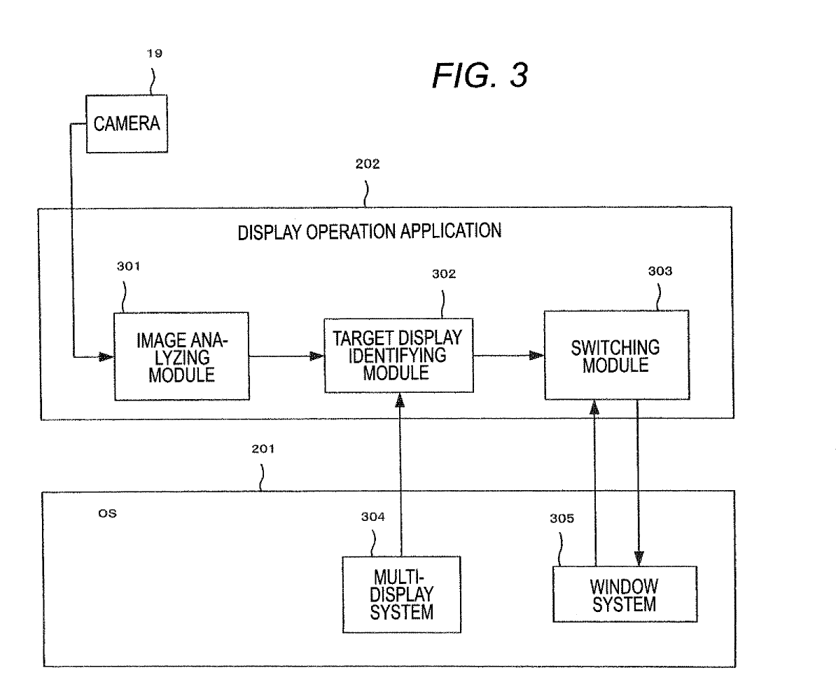

The OS 201 is software which provides basic functions used in common to a large number of application software to manage the computer system as a whole. For example, the basic functions are an input/output function of performing input from the keyboard 13 and output to the display 17, a management function of managing the HDD 111 and the memory 103. The OS 201 further has a multi-display function of displaying application windows on a plurality of displays. These functions will be described later with reference to FIG. 3.

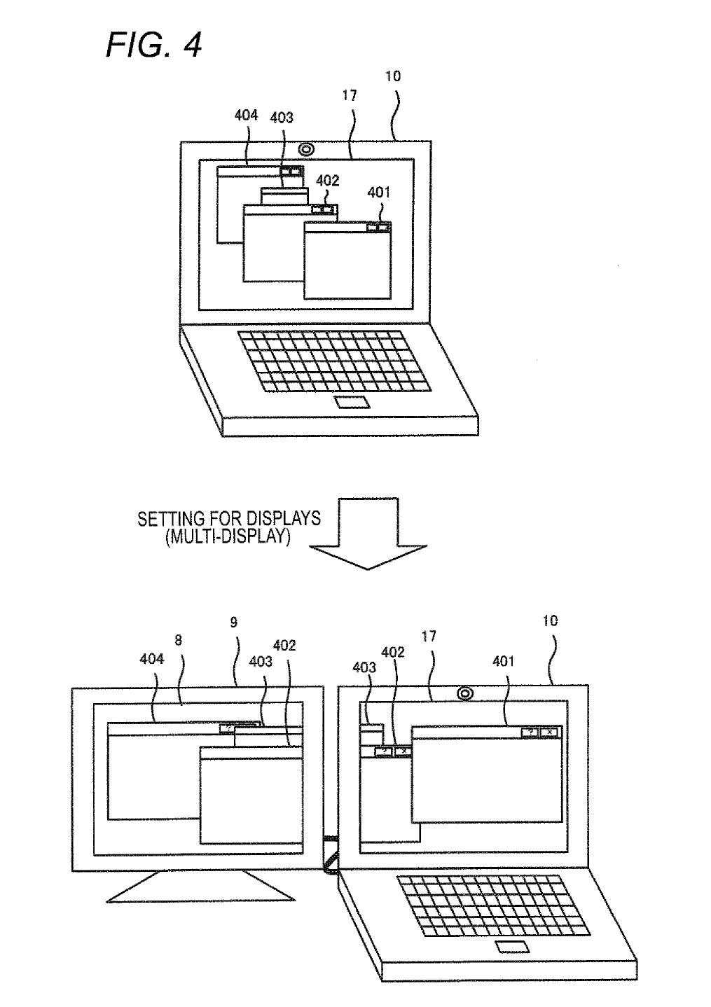

The display operation application program 202 is software for executing the process of switching an operation input to an application window when multi-display has been set. For example, the display operation application program 202 in the embodiment identifies a display currently gazed on by the user by analyzing the user's face image picked up by the camera 19 and performs the process of switching an operation input to an application window placed on the display. This display operation application program 202 will be described later with reference to FIGS. 3 and 4.

For example, the application program A 203 and the application program B 204 may be a TV application program, or a Web browser application program. The TV application program is software for executing a TV function. The Web browser application program is software for browsing Web pages.

In addition, in each of these application programs, while an application window for execution of a process is displayed on the LCD 17, an image corresponding to an operation input from an input device such as the keyboard 13 is output to the LCD 17.

In addition, the CPU 101 runs a BIOS (Basic Input Output System) stored in the BIOS-ROM 109. The BIOS is a program for hardware control.

The north bridge 102 is a bridge device for connecting a local bus of the CPU 101 and the south bridge 104 to each other. The north bridge 102 further has a built-in memory controller for access control of the main memory 103. The north bridge 102 further has a function of executing communication with the GPU 105 through a serial bus according to the PCI EXPRESS Standard, etc.

The GPU 105 is a display controller for controlling the LCD 17 used as a display monitor of the computer 10. A display signal generated by this CPU 105 is sent to the LCD 17.

The south bridge 104 controls respective devices on an LPC (Low Pin Count) bus and respective devices on a PCI (Peripheral Component Interconnect) bus. The south bridge 104 further has a built-in IDE (Integrated Drive Electronics) controller for controlling the hard disk drive (HDD) 111 and a DVD drive not shown. The south bridge 104 further has a function of executing communication with the sound controller 106.

The sound controller 106 is a sound source device. The sound controller 106 outputs audio data as a reproduction target to a speaker 18.

The embedded controller/keyboard controller IC (EC/KBC) 112 is a one-chip microcomputer into which an embedded controller for electronic power management and a keyboard controller for controlling the keyboard (KB) 13 and a touch pad 16 are integrated. This embedded controller/keyboard controller IC (EC/KBC) 112 has a function of powering on/off the computer 10 in accordance with a user's operation of a power button 14.

The network controller 113 establishes communication with a wire or wireless network. This network controller 113 serves as a communication portion for executing communication with the Internet through an external router, etc.

The camera 19 captures an image of the user's face in accordance with an input from the keyboard 13 and the touch pad 16.

The function of the display operation application program 202 will be described below with reference to FIGS. 3 and 4. FIG. 3 is a block diagram showing the configuration of the display operation application program 202 in the embodiment. FIG. 4 is a view showing multi-display implemented by the display operation application program 202 in the embodiment.

The display operation application program 202 includes an image analyzing module 301, a target display identifying module 302, and a switching module 303. For execution of the process of switching an operation input to an application window placed on a display gazed on by the user, the display operation application program 202 acquires setting information about arrangement of displays on the OS 201 and information about application windows from a multi-display system 304 and a window system 305 which are provided inside the OS 201.

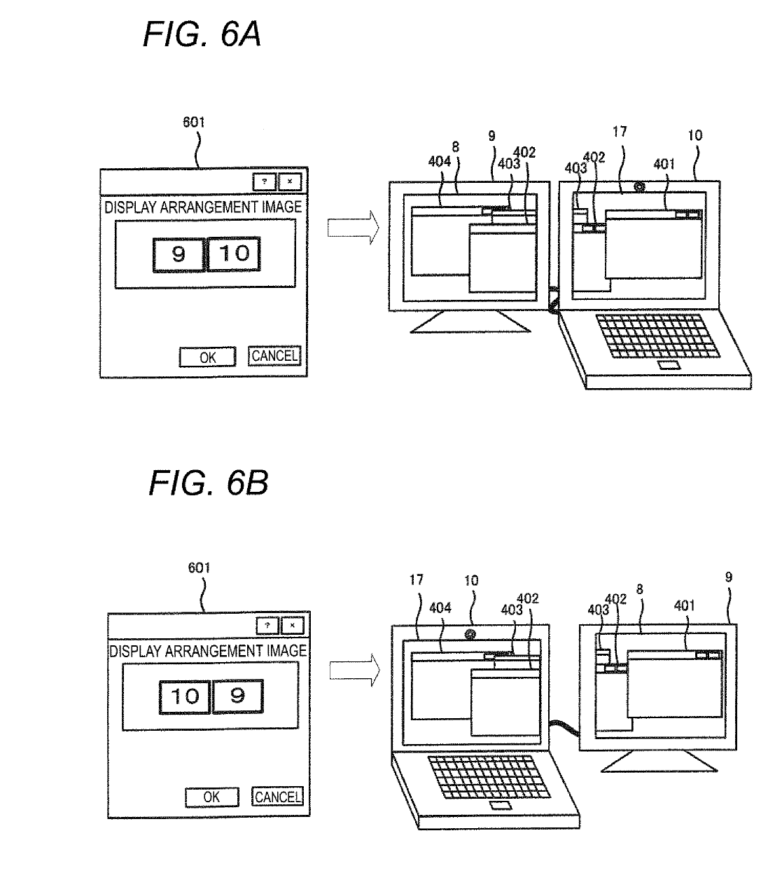

The setting information about arrangement of displays on the OS 201 is information which expresses arrangement of the respective displays and which is set when multi-display is executed. The setting information about display arrangement will be described later with reference to FIGS. 6A and 6B.

The image analyzing module 301 analyzes a user's face image captured up by the camera 19, extracts feature points of the user's face, and outputs the feature points of the user's face to the target display identifying module 302.

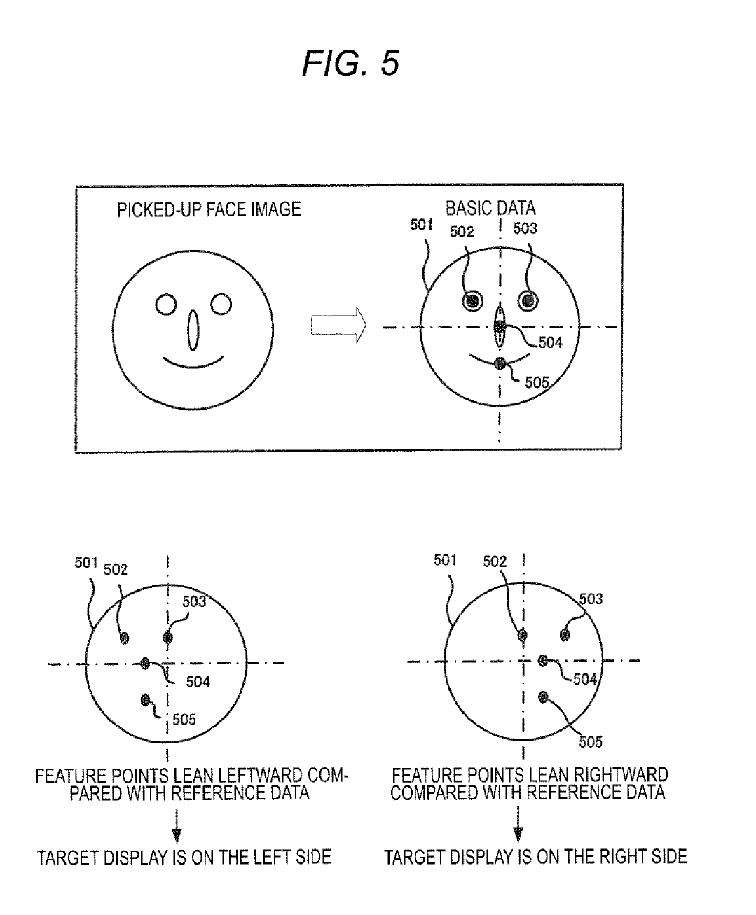

The image analyzing module 301 further has a function of specifying positions of user's eyeballs relative to user's eye contours and outputting the specified positions of the user's eyeballs to the target display identifying module 302. This feature point detection method will be described later with reference to FIG. 5.

Upon reception of the information about the feature points of the user's face and the information about the positions of the user's eyeballs relative to the user's eye contours from the image analyzing module 301 and upon reception of the setting information about display arrangement on the OS 201 from the multi-display system 304, the target display identifying module 302 identifies a display currently gazed on by the user and outputs the identified display to the switching module 303.

The switching module 303 periodically checks whether the display currently gazed on by the user and identified by the target display identifying module 302 has been changed or not. When the display gazed on by the user has been changed, the switching module 303 refers to the information about application windows from the window system 305, and outputs an instruction to the window system 305 to switch a designation of a command input from the keyboard 13 or the like to an application window displayed foremost on the display identified after the change.

The information about application windows is information about a sequence of application windows which are displayed on each display so as to overlap one another. The switching module 303 can detect a foremost one of these application windows by referring to the information. For example, in the example of FIG. 4, the application window displayed foremost on the display device 9 is a window 402 whereas the application window displayed foremost on the computer 10 is a window 401.

The multi-display system 304 outputs/displays application windows handled by the computer 10 on a plurality of displays. For example, as shown in FIG. 4, the multi-display system 304 can display application windows on the LCD 17 and, at the same time, can display other application windows handled by the computer 10 on the display 8 of the external display device 9 or the like. In the multi-display, for example, application windows to be processed by one display can be distributed into two displays to reduce troublesomeness and complication of the processing. In addition, the multi-display system 304 outputs the setting information of display arrangement on the OS 201, acquired when the multi-display is set, to the target display identifying module 302.

The window system 305 manages the information about application windows displayed on each display and outputs the information to the switching module 303. In addition, the window system 305 executes a process of switching an operation input to an application window placed on a display currently gazed on by the user under the support from the switching module 303.

Information about feature points of a user's face extracted by the image analyzing module 301 in the embodiment will be described below with reference to FIG. 5. FIG. 5 shows a method of extracting the feature points of the user's face in the embodiment.

As shown in FIG. 5, the image analyzing module 301 in the embodiment determines respective feature points of a left eye 502, a right eye 503, a nose 504, a mouth 5051 etc. based on a user's face 501, for example, picked up by the camera 19, and then generates basic data. In addition, the image analyzing module 301 in the embodiment specifies a current direction of the user's face by judging which of four sides (i.e. left, right, top and bottom sides) the respective feature points 502 to 505 in terms of the user's face 501 lean to.

When, for example, the respective feature points 502 to 505 lean to the left side, the image analyzing module 301 determines that the current direction of the user's face is left. On this occasion, the image analyzing module 301 regards the display currently gazed on by the user as being located on the left side of the computer 10 provided with the camera, so that a process of switching an operation input to an application window placed on the display is executed.

Although description has been given here to an example in which the feature points of the left eye 502, the right eye 503, the nose 504 and the mouth 505 are extracted from the user's face 501, the invention is not limited thereto and other feature points such as eyebrows and ears may be used as long as these feature points can be used for specifying the current direction of the user's face. In the embodiment, for example, the current direction of the user's face can be specified based on the positions of the eyeballs relative to the eye contours. In this case, respective opposite ends of the eye contours, pupils in the centers of the eyeballs, etc. are extracted as feature points. Description about a method for specifying the current direction of the user's face based on the positions of the eyeballs relative to the eye contours will be omitted because the process after extraction of the feature points is the same.

Next, a setting method for display arrangement in the embodiment will be described. FIGS. 6A and 6B show the setting method for display arrangement in the embodiment. Upon reception of a multi-display setting request, the multi-display system 304 in the embodiment displays a multi-display setting screen 601, e.g. shown in FIG. 6A or 6B and makes the user set arrangement of the respective displays on the OS 201. For example, display images of the respective devices shown in a field “display arrangement image” are set to be placed suitably by use of a mouse or the like.

As shown in FIG. 6A or 6B, in the embodiment, arrangement of the respective displays on the OS 201 can be set when, for example, multi-display is set. When, for example, the computer 10 and the external display device 9 are disposed side by side in a room space so that the external display device 9 is disposed on the left side of the computer 10, arrangement can be set in such a manner that the display 8 of the external display device 9 is connected on the left side of the LCD 17 of the computer 10 as shown in FIG. 6A.

On the other hand, when the external display device 9 is disposed on the right side of the computer 10, arrangement can be set in such a manner that the display 8 of the external display device 9 is connected on the right side of the LCD 17 of the computer 10 as shown in FIG. 6B.

As described above, in the embodiment, arrangement of the respective displays on the OS 201 can be set correspondingly to the spatial arrangement of the computer 10 and the external display device 9. Moreover, in the embodiment, when the arrangement of the respective displays on the OS 201 has been set, this information is output to the target display identifying module 302.

Assume now a state in which the external display device 9 is arranged on the left side of the computer 10 in terms of both spatial arrangement and OS arrangement as shown in FIG. 6A. When, for example, only the OS arrangement is changed from this state so that the external display device 9 will be arranged on the right side of the computer 10, it is necessary to change the process of specifying the current direction of the user's face in accordance with the change of the OS arrangement in order to make it easy for the user to perform the process of switching an operation input intuitively.

Therefore, the embodiment is provided with a function of changing the process of specifying the direction of the user's face in accordance with change of setting for the display arrangement on the OS 201. In the embodiment, this function permits the user to execute the process of switching an application operation input intuitively even under the situation that both spatial arrangement and OS arrangement are set so as to be contrary to each other.

Although an example of multi-display based on the computer 10 and the external display device 9 has been described in the embodiment to simplify the description thereof, the invention is not limited thereto and a number of external display devices allowed to be connected to the computer 10 may be provided. In this case, a number of cameras 19 for picking up user's face images and extracting feature points from the images may be provided so that the direction of the user's face can be specified more accurately.

In the embodiment, it is assumed that the multi-display function can be executed with use of a device having no display such as a projector in place of the external display device as long as the device having no display can be connected to the computer 10. In this case, the display screen gazed on by the user corresponds to a screen or the like irradiated with light emitted from the projector to form an image, so that the direction of the user's face can be specified in accordance with setting of arrangement of the screen or the like.

Incidentally, the camera 19 in the embodiment picks up user's face images successively in accordance with an input from the input device such as the keyboard 13, so that an average value of the direction of the user's face is calculated. Accordingly, the display gazed on by the user can be specified more accurately, for example, under the situation or the like that a plurality of external display devices are installed in the same direction viewed from the computer 10.

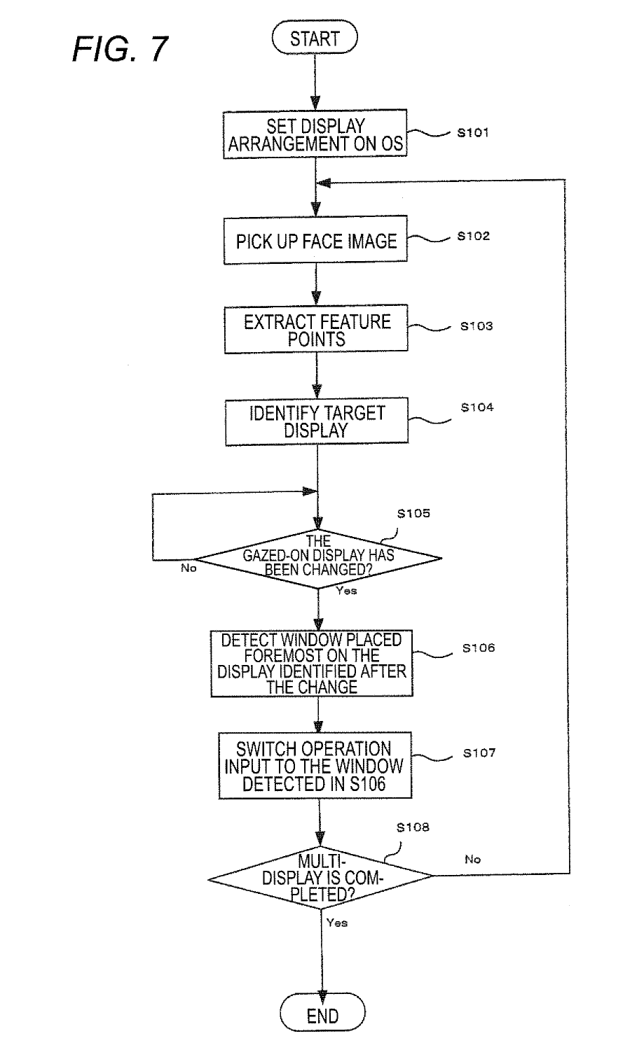

Referring next to FIG. 7, a flow of multi-display setting in the embodiment will be described. FIG. 7 is a flow chart showing a flow of multi-display setting in the embodiment.

Upon reception of a multi-display setting request, the multi-display system 304 in the embodiment displays an application window 601 for setting display arrangement on the OS 201, for example, on the LCD 17 so that the user can determine display arrangement on the OS 201 through the application window 601 (S101).

When the display arrangement on the OS 201 is determined and multi-display is executed, the camera 19 in the embodiment picks up user's face images successively in accordance with an input from the keyboard 13 or the Like (S102), and outputs the user's face images to the image analyzing module 301.

Upon reception of the user's face images, the image analyzing module 301 analyzes the user's face images and extracts feature points of the user's face from the images (S103), and outputs the feature points of the user's face to the target display identifying module 302. Upon reception of the information about the feature points of the user's face, the target display identifying module 302 acquires setting information about the display arrangement on the OS 201 from the multi-display system 304 and is identifies a display currently gazed on by the user (S104), and outputs this information to the switching module 303.

Then, the switching module 303 periodically checks whether the display currently gazed on by the user has been changed or not, based on the information received from the target display identifying module 302 (S105). When the display gazed on by the user has been changed (Yes in S105), the switching module 303 detects an application window placed foremost on the display by referring to information expressing the display currently gazed on by the user and identified by the target display identifying module 302 and information about the application windows from the window system 305 (S106).

Then, the switching module 303 outputs an instruction to the window system 305 to switch a designation of an operation input from the keyboard 13 or the like to the application window detected by the step S105. Upon reception of this instruction, the window system 305 executes a process of switching an operation input to the application widow placed foremost on the display currently gazed on by the user (S107).

When decision is made in the step S105 that the display gazed on by the user has not been changed (No in S105), the switching module 303 repeats the process of the step S105.

Then, the multi-display system 304 checks whether a multi-display completion request has been received or not (S108). When the multi-display completion request has not been received (No in S108), the multi-display system 304 returns the routine of processing to the step S102. When the multi-display completion request has been received (Yes in S108), the multi-display system 304 terminates the processing.

As described above, the embodiment achieves the provision of an information processing apparatus which can perform an input switching operation for an application in consideration of user's convenience.

In the embodiment, the current direction of the user's face can be specified based on feature points extracted from the user's face image picked up by the camera 19. In this manner, the display gazed on by the user can be identified without necessity of largely changing the working environment of the computer, such as necessity of mounting an eye camera.

Moreover, in the embodiment, when the display gazed on by the user has been changed, a designation of a command input from the keyboard or the like can be switched to an application window displayed foremost on the display identified after the change. Accordingly, in the embodiment, an input switching operation for an application can be performed in a state in which user's hands are free.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a display controller configured to control a plurality of display devices each having a display screen to display one or more application windows on the respective display screen;
an user interface configured to accept an operation input by a user for operating the application window;
a screen identifying module configured to identify a target display screen from among the display screens of the display devices, the target display screen being currently gazed on by a user; and
a switch configured to switch a subject of the operation input through the user interface to the application windows displayed on the target display screen.

2. The apparatus of claim 1 further comprising a sequence ascertaining module configured to ascertain an overlapping sequence of the application windows which are displayed on the target display screen so as to overlap with one another,
wherein the switch switches the subject of the operation input from the user interface to the foremost application window on the target display screen by referring to the overlapping sequence ascertained by the sequence ascertaining module.

3. The apparatus of claim 2 further comprising:
a screen arrangement setting module configured to set an arrangement of the display screens on an operating system; and
a detection module configured to detect a direction of a user's face,
wherein the screen identifying module identifies the target display screen based on the arrangement of the display screens set on the operating system by the screen arrangement setting module and the direction of the user's face detected by the detection module.

4. The apparatus of claim 3, wherein the screen identifying module changes the detected direction of the user's face corresponding to the arrangement of the display screens in accordance with a change made to the arrangement of the display screens set on the operating system by the screen arrangement setting module.

5. The apparatus of claim 4 further comprising an image pickup device configured to capture an image of the user's face,
wherein the screen identifying module identifies the target display screen based on the image captured by the image pickup device.

6. The apparatus of claim 5, wherein the image pickup device captures the image of the user's face in accordance with an operation input by the user through the user interface.
